(19) United States
(12) Patent Application Publication
(10) Pub. No.: US 2016/0088710 A1
(43) Pub. Date: Mar. 24, 2016

(54) METHOD AND APPARATUS FOR CONTROLLING SMART LIGHT

(71) Applicant: Xiaomi Inc., Beijing (CN)

(72) Inventors: Qiao REN, Beijing (CN); Yun YANG, Beijing (CN); Ziguang GAO, Beijing (CN)

(73) Assignee: Xiaomi Inc.

(21) Appl. No.: 14/737,628

(22) Filed: Jun. 12, 2015

Related U.S. Application Data
(63) Continuation of application No. PCT/CN2015/074445, filed on Mar. 18, 2015.

(30) Foreign Application Priority Data
Sep. 22, 2014 (CN) 201410486834.8

(51) Int. Cl. H05B 37/02

(52) U.S. Cl. CPC H05B 37/0218

(57) ABSTRACT

A method for controlling a smart light includes acquiring status information of a current scene, judging whether the current scene complies with a preset scene condition according to the status information, inquiring a pre-stored light effect configuration library according to the preset scene condition to determine a light effect parameter corresponding to the preset scene condition if the current scene complies with the preset scene condition, generating a light control instruction corresponding to the preset scene condition and including the light effect parameter, and sending the light control instruction to the smart light.

### CROSS-REFERENCE TO RELATED APPLICATIONS

This application is a continuation of International Application No. PCT/CN2015/074445, filed Mar. 18, 2015, which is based upon and claims priority to Chinese Patent Application No. 201410486834.8, filed Sep. 22, 2014, the entire contents of both of which are incorporated herein by reference.

### TECHNICAL FIELD

The present disclosure relates to electronic technologies and, more particularly, to a method and apparatus for controlling a smart light.

### BACKGROUND

Smart lights are controllable light sources. In conventional technologies, a user needs to manually control a smart light using a controller.

### SUMMARY

In accordance with the present disclosure, there is provided a method for controlling a smart light. The method includes acquiring status information of a current scene, judging whether the current scene complies with a preset scene condition according to the status information, inquiring a pre-stored light effect configuration library according to the preset scene condition to determine a light effect parameter corresponding to the preset scene condition if the current scene complies with the preset scene condition, generating a light control instruction corresponding to the preset scene condition and including the light effect parameter, and sending the light control instruction to the smart light.

Also in accordance with the present disclosure, there is provided an apparatus for controlling a smart light. The apparatus includes a processor and a non-transitory computer-readable storage medium storing instructions. The instructions, when executed by the processor, cause the processor to acquire status information of a current scene, judge whether the current scene complies with a preset scene condition according to the status information, inquire a pre-stored light effect configuration library according to the preset scene condition to determine a light effect parameter corresponding to the preset scene condition if the current scene complies with the preset scene condition, generate a light control instruction corresponding to the preset scene condition and including the light effect parameter, and send the light control instruction to the smart light.

Also in accordance with the present disclosure, there is provided a non-transitory computer-readable storage medium storing instructions. The instructions, when executed by a processor in a device, cause the device to acquire status information of a current scene, judge whether the current scene complies with a preset scene condition according to the status information, inquire a pre-stored light effect configuration library according to the preset scene condition to determine a light effect parameter corresponding to the preset scene condition if the current scene complies with the preset scene condition, generate a light control instruction corresponding to the preset scene condition and including the light effect parameter, and send the light control instruction to a smart light.

According to the present disclosure, corresponding controls of a smart light can be conducted according to changes of the scene statuses so as to realize intellectualized control of the smart light and expand the applications of the smart light. The control of the smart light can be enabled free from manual operation, automatic control of the smart light can be realized, and the smart light control can be made more convenient.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for controlling a smart light, according to an exemplary embodiment.

FIG. 2 is a flow chart of a method for controlling a smart light, according to another exemplary embodiment.

FIG. 3 is a diagram showing an application scene of the method shown in FIG. 2.

FIG. 4 is a flow chart of a method for controlling a smart light, according to another exemplary embodiment.

FIG. 5 is a diagram showing an application scene of the method shown in FIG. 4.

FIG. 6 is a flow chart of a method for controlling a smart light, according to another exemplary embodiment.

FIG. 7 is a diagram showing an application scene of the method shown in FIG. 6.

FIG. 8 is a flow chart of a method for controlling a smart light, according to another exemplary embodiment.

FIG. 9 is a diagram showing an application scene of the method shown in FIG. 8.

FIG. 10 is a block diagram of an apparatus for controlling a smart light, according to an exemplary embodiment.

FIG. 11 is a block diagram of another apparatus for controlling a smart light, according to another exemplary embodiment.

FIG. 12 is a block diagram of an apparatus suitable for controlling a smart light, according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise specified. The implementations set forth in the following description of exemplary embodiments do not represent all implementations consistent with the invention. Instead, they are merely examples of devices and methods consistent with some aspects related to the invention as recited in the appended claims. Method consistent with embodiments of the present disclosure can be implemented in a control device, such as, for example, a cloud server, a router, a personal computer, or a terminal device.

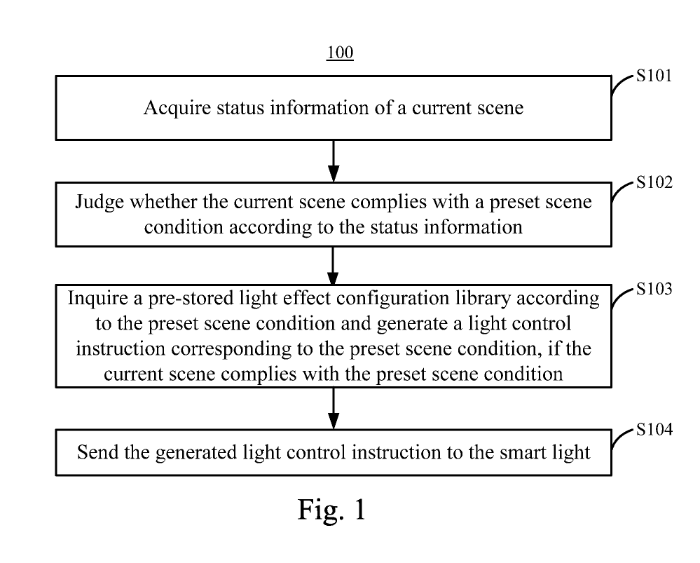

FIG. 1 is a flow chart of an exemplary method 100 for controlling a smart light consistent with embodiments of the present disclosure. As shown in FIG. 1, at S101, status information of a current scene is acquired. For example, the status information of the current scene can be acquired from another device or be acquired locally.

At S102, whether the current scene complies with a preset scene condition is judged according to the status information.

In some embodiments, one or more preset scene conditions and one or more light effect parameters corresponding to the preset scene conditions that are set by a user can be received and stored in advance. For instance, the user may set the preset scene conditions and the corresponding light effect parameters using an application in a terminal, and the terminal transmits the preset scene conditions and the light effect parameters. The control device receives the preset scene conditions and the corresponding light effect parameters sent by the terminal, and stores the received preset scene conditions and the corresponding light effect parameters.

Alternatively, the preset scene conditions and the corresponding light effect parameters may be acquired by, for example, acquiring the preset scene conditions and the corresponding light effect parameters from a local configuration file.

In some embodiments, the status information includes communication event information of a target contact. In this scenario, judging whether the current scene complies with a preset scene condition (S102) includes judging whether a specific communication event is conducted by the target contact according to the communication event information.

For instance, the communication event information of the target contact may include sharing contents by the target contact on a preset network platform or receiving of a communication sent by the target contact. For example, the preset network platform includes a preset social website, the target contact includes a preset account, sharing contents includes publishing an article, and the preset scene condition is that the preset account of the preset social website publishes an article. Thus, at S101, communication event information, sent by the preset social website, of the preset account publishing an article on the social website is received. At S102, since the preset account publishes an article on the preset social website according to the communication event information, it is determined that the status information of the current scene complies with the preset scene condition. As another example, the preset scene condition includes that the target contact sends a communication. At S101, the communication event information of receiving a communication sent by the target contact is acquired. At S102, since a communication sent by the target contact is received according to the acquired communication event information, it is determined that the status information of the current scene complies with the preset scene condition.

In some embodiments, the status information includes moving object monitoring event information in a target region. In this scenario, judging whether the current scene complies with a preset scene condition (S102) includes judging whether a moving object passes in the target region according to the moving object monitoring event information. For example, the preset scene condition includes that a person passes in the target region. Thus, at S101, the moving object monitoring event information that a person passes in the target region is received. At S102, since a person passes in the target region according to the moving object monitoring event information, it is determined that the current scene complies with the preset scene condition.

In some embodiments, the status information includes device access event information in the target region. The device access event information includes an identity and an access time of a device. In this scenario, judging whether the current scene complies with a preset scene condition (S102) includes judging whether a first access of a specific device is conducted in the target region within a preset duration according to the device access event information. For example, the preset scene condition includes that a user carrying a specific smartband is back home. Thus, at S101, the device access event information, which indicates the access of the smartband, sent by a smart box at home is received. The device access event information includes an ID and an access time of the accessing smartband. At S102, whether it is the first access of the accessing smartband at home within a preset duration is judged according to the ID and the access time of the accessing smartband in the access event information. If it is the first access of the accessing smartband at home within the preset duration, the current scene is determined to comply with the preset scene condition.

In some embodiments, the status information includes time information. In this scenario, judging whether the current scene complies with a preset scene condition (S102) includes judging whether the current time reaches a preset time according to the time information.

For example, at S102, after it is judged, according to the device access event information, that it is the first access of a specific device in the target region within a preset duration, it is further judged whether the current time reaches the preset time according to the time information. If the current time reaches the preset time, the current scene is determined to comply with the preset scene condition.

As another example, the preset scene condition includes that the current time reaches the preset time. Thus, at S102, if it is judged that the current time reaches the preset time according to the time information, the current scene is determined to comply with the preset scene condition.

At S103, if the current scene complies with the preset scene condition, a pre-stored light effect configuration library is inquired according to the preset scene condition and a light control instruction corresponding to the preset scene condition is generated. The light control instruction includes a light effect parameter enabling the smart light to present a preset light effect. The light effect configuration library includes a plurality of preset scene conditions and light effect parameters corresponding to respective preset scene conditions. In some embodiments, the light effect parameter includes at least one of the following parameters: a light on-off parameter, a light flickering times parameter, a light color parameter, and a light intensity parameter.

At S104, the generated light control instruction is sent to the smart light so that the smart light presents a light effect corresponding to the preset scene condition.

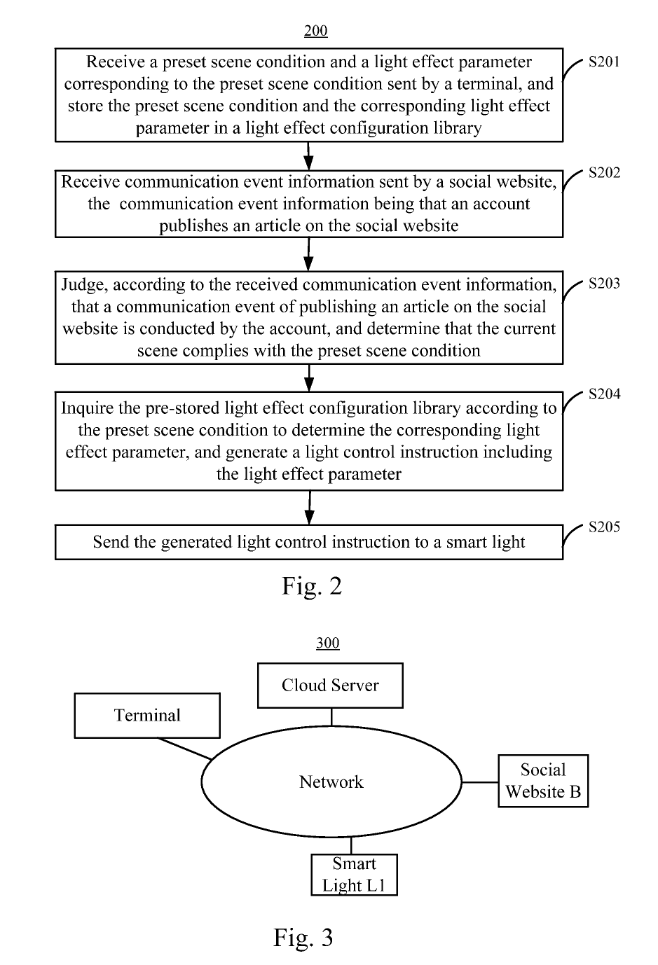

FIG. 2 is a flow chart of an exemplary method 200 for controlling a smart light consistent with embodiments of the present disclosure. FIG. 3 is a diagram showing an application scene 300 of the method 200. As shown in FIG. 3, the application scene 300 includes a cloud server connected to a social website B, a terminal, and a smart light L1 through a network. The preset scene condition includes that an account A publishes an article on the social website B and the corresponding light effect parameter includes flickering for n1 times. The preset scene condition and the corresponding light effect may be set by a user in a terminal application. The method 200 is implemented in the cloud server.

As shown in FIG. 2, at S201, the cloud server receives the preset scene condition and the light effect parameter corresponding to the preset scene condition sent by the terminal, and stores the preset scene condition and the corresponding light effect parameter in a light effect configuration library.

At S202, the cloud server receives communication event information, sent by the social website B, indicating that the account A published an article on the social website B.

At S203, according to the received communication event information, the cloud server judges that the communication event of publishing an article on the social website B is conducted by the account A, and determines that the current scene complies with the preset scene condition.

At S204, the cloud server inquires the pre-stored light effect configuration library according to the preset scene condition. By inquiring the library, the cloud server determines that the corresponding light effect parameter is flickering for n1 times, and generates a light control instruction including the light effect parameter of flickering for n1 times.

At S205, the cloud server sends the generated light control instruction to the smart light L1, instructing the smart light L1 to flicker for n1 times.

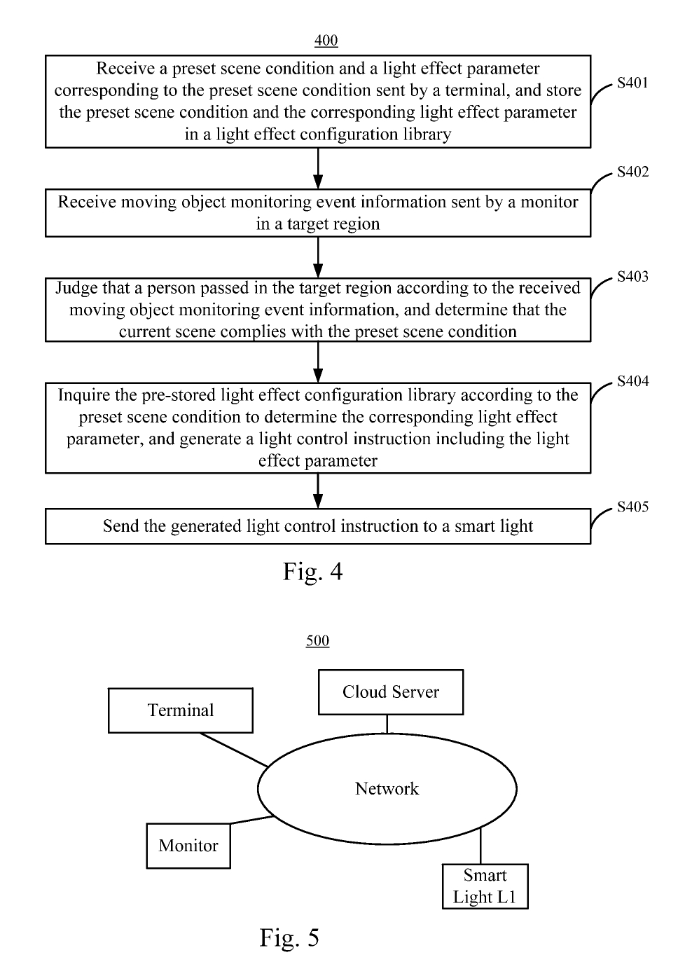

FIG. 4 is a flow chart of an exemplary method 400 for controlling a smart light consistent with embodiments of the present disclosure. FIG. 5 is a diagram showing an application scene 500 of the method 400. As shown in FIG. 5, the application scene 500 includes a cloud server connected to a monitor, a terminal, and a smart light L1 through a network. The preset scene condition includes that a person passes, and the corresponding light effect includes that the smart light L1 flickers for n2 times. The preset scene condition and the corresponding light effect can be set by a user in a terminal application. The method 400 is implemented in the cloud server.

As shown in FIG. 4, at S401, the cloud server receives the preset scene condition and the light effect parameter corresponding to the preset scene condition sent by the terminal, and stores the preset scene condition and the corresponding light effect parameter in a light effect configuration library.

At S402, the cloud server receives moving object monitoring event information sent by the monitor located in a target region.

At S403, according to the received moving object monitoring event information, the cloud server judges that a person passed in the target region, and determines that the current scene complies with the preset scene condition.

At S404, the cloud server inquires the pre-stored light effect configuration library according to the preset scene condition. By inquiring the library, the cloud server determines that the corresponding light effect parameter is flickering for n2 times, and generates a light control instruction including the light effect parameter of flickering for n2 times.

At S405, the cloud server sends the generated light control instruction to the smart light L1, instructing the smart light L1 to flicker for n2 times.

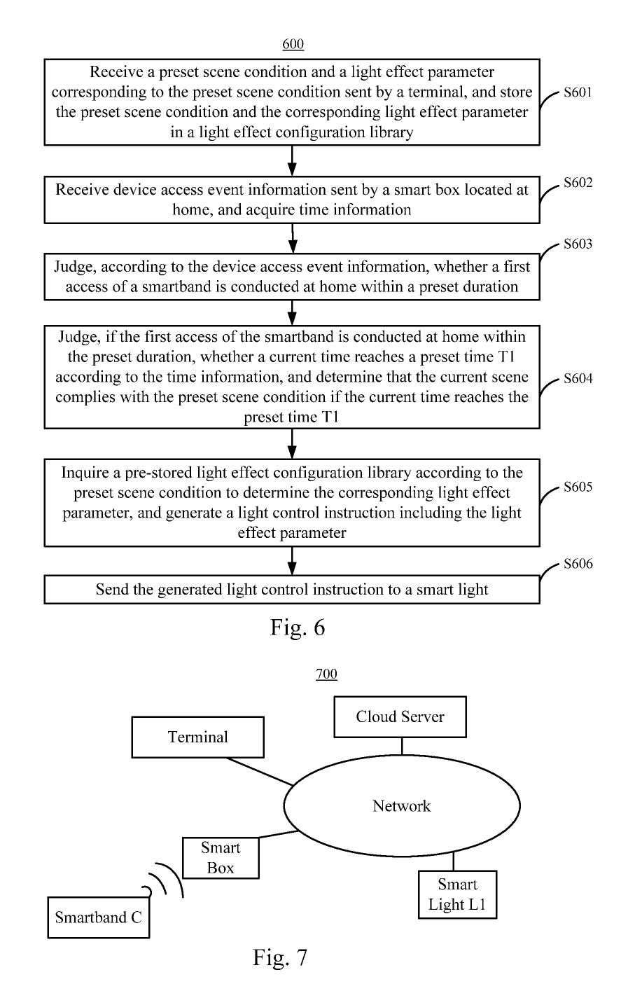

FIG. 6 is a flow chart of an exemplary method 600 for controlling a smart light consistent with embodiments of the present disclosure. FIG. 7 is a diagram showing an application scene 700 of the method 600. As shown in FIG. 7, the application scene 700 includes a cloud server connected to a smart box, a terminal, and a smart light L1 through a network. The smart box is located at a user's home and has a bluetooth communication device. The preset scene condition includes that the user carrying a smartband C is back home and the time reaches a preset time T1, and the corresponding light effect includes turning on the smart light L1. The preset scene condition and the corresponding light effect can be set by a user in a terminal application. The smartband C also has a bluetooth communication device. The method 600 is implemented in the cloud server.

At S601, the cloud server receives the preset scene condition and the light effect parameter corresponding to the preset scene condition sent by the terminal, and stores the preset scene condition and the corresponding light effect parameter in a light effect configuration library.

At S602, the cloud server receives device access event information sent by the smart box, and acquires time information. The device access event information includes an identity and an access time of the smartband C. For instance, when the smartband C is close to the smart box, the smartband C accesses the smart box. The smart box acquires an identity (for example, a type and/or a serial number) and an access time of the smartband C, and generates the device access event information including the identity and the access time of the smartband.

At S603, according to the device access event information, the cloud server judges whether a first access of the smartband C is conducted at home within a preset duration.

At S604, if it is the first access of the smartband C at home within the preset duration, the cloud server judges whether the current time reaches a preset time T1 according to the time information. If the current time reaches the preset time T1, the cloud server determines that the current scene complies with the preset scene condition.

At S605, the cloud server inquires the pre-stored light effect configuration library according to the preset scene condition. By inquiring the library, the cloud server determines that the corresponding light effect parameter is to turn on the smart light L1, and generates a light control instruction including the light effect parameter of turning on the smart light L1.

At S606, the cloud server sends the generated light control instruction to the smart light L1, instructing the smart light L1 to turn on.

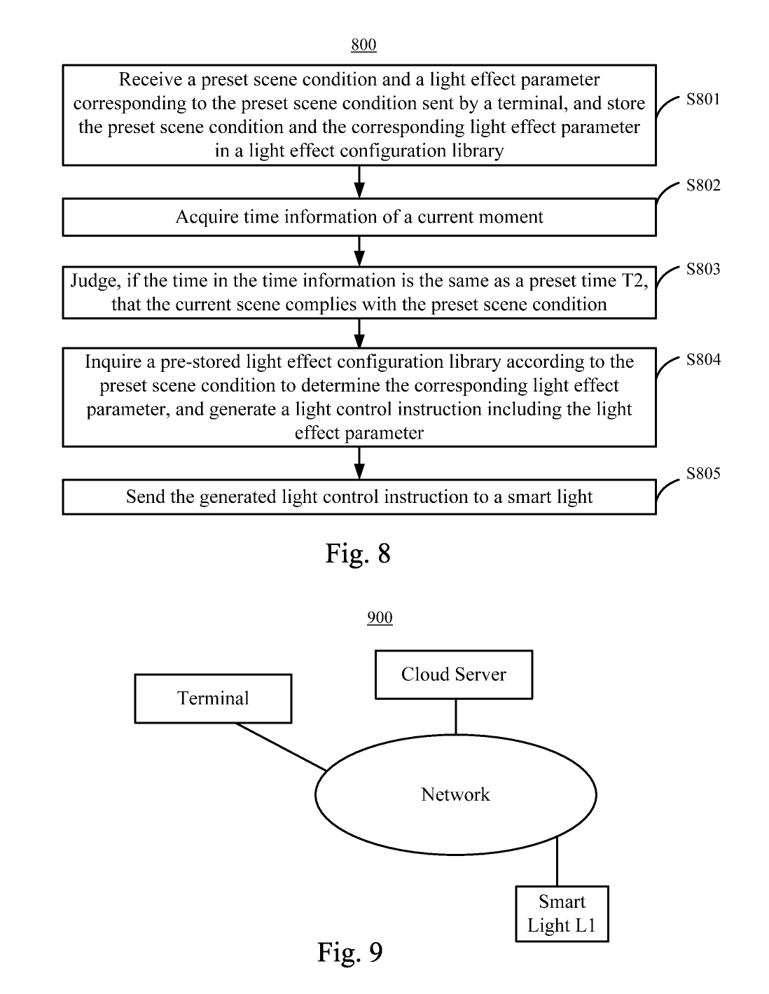

FIG. 8 is a flow chart of an exemplary method 800 for controlling a smart light consistent with embodiments of the present disclosure. FIG. 9 is a diagram showing an application scene 900 of the method 800. As shown in FIG. 9, the application scene 900 includes a cloud server connected to a terminal and a smart light L1 through a network. The preset scene condition includes that the time reaches a preset time T2, and the corresponding light effect includes that the smart light L1 flickers for n4 times. The method 800 is implemented in the cloud server.

As shown in FIG. 8, at S801, the cloud server receives the preset scene condition and the light effect parameter corresponding to the preset scene condition sent by the terminal, and stores the preset scene condition and the corresponding light effect parameter in a light effect configuration library.

At S802, the cloud server acquires time information of a current time.

At S803, if the time in the time information is the same as the preset time T2, the cloud server judges that the current scene complies with the preset scene condition.

At S804, the cloud server inquires the pre-stored light effect configuration library according to the preset scene condition. By inquiring the library, the cloud server determines that the corresponding light effect parameter is flickering for n4 times, and generates a light control instruction including the light effect parameter of flickering for n4 times.

At S805, the cloud server sends the generated light control instruction to the smart light L1, instructing the smart light L1 to flicker for n4 times.

In the examples discussed above, methods consistent with the present disclosure are implemented in the cloud server, and the light effect includes flicking and/or turning on the light. In some embodiments, such methods can be implemented in various devices and the light effect can include various effects. Moreover, a plurality of preset scene conditions may be set at the same time.

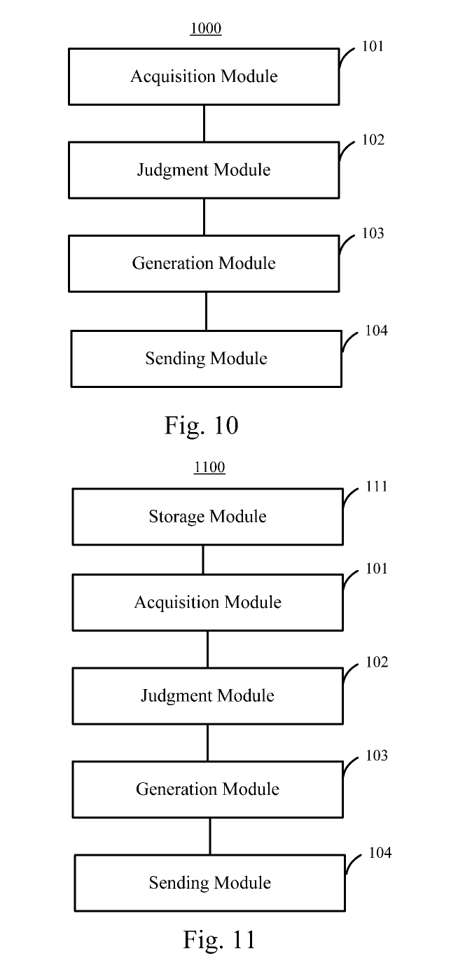

FIG. 10 is a block diagram of an exemplary apparatus 1000 for controlling a smart light consistent with embodiments of the present disclosure. As shown in FIG. 10, the apparatus 1000 includes an acquisition module 101, a judgment module 102, a generation module 103, and a sending module 104. The acquisition module 101 is configured to acquire status information of a current scene. The judgment module 102 is configured to judge whether the current scene complies with a preset scene condition according to the status information acquired by the acquisition module 101. The generation module 103 is configured to inquire a pre-stored light effect configuration library according to the preset scene condition and generate a light control instruction corresponding to the preset scene condition when the judgment module 102 judges that the current scene complies with the preset scene condition. The light control instruction includes a light effect parameter enabling the smart light to present a preset light effect. The light effect configuration library includes a plurality of preset scene conditions and light effect parameters corresponding to respective preset scene conditions. The sending module 104 is configured to send the light control instruction generated by the generation module 103 to the smart light so that the smart light presents a light effect corresponding to the preset scene condition.

FIG. 11 is a block diagram of another exemplary apparatus 1100 for controlling a smart light consistent with embodiments of the present disclosure. The apparatus 1100 is similar to the apparatus 1000, except that the apparatus 1100 further includes a storage module 111 configured to receive and store the preset scene condition and the light effect parameter corresponding to the preset scene condition. The preset scene condition and the corresponding light effect parameter can be set by a user.

In some embodiments, the status information includes communication event information of a target contact, and the judgment module 102 includes a first judgment submodule configured to judge whether a specific communication event is conducted by the target contact according to the communication event information. In some embodiments, the communication event information of the target contact includes sharing contents by the target contact on a preset network platform or receiving communications sent by the target contact.

In some embodiments, the status information includes moving object monitoring event information in a target region, and the judgment module 102 includes a second judgment submodule configured to judge whether a moving object passes in the target region according to the moving object monitoring event information.

In some embodiments, the status information includes device access event information in a target region. The device access event information includes an identity and an access time of the device. The judgment module 102 includes a third judgment submodule configured to judge whether a first access of a specific device is conducted in the target region within a preset duration according to the device access event information.

In some embodiments, the status information includes time information, and the judgment module 102 includes a fourth judgment submodule configured to judge whether the current time reaches a preset time according to the time information.

In some embodiments, the light effect parameter includes at least one of a light on-off parameter, a light flickering times parameter, a light color parameter, or a light intensity parameter.

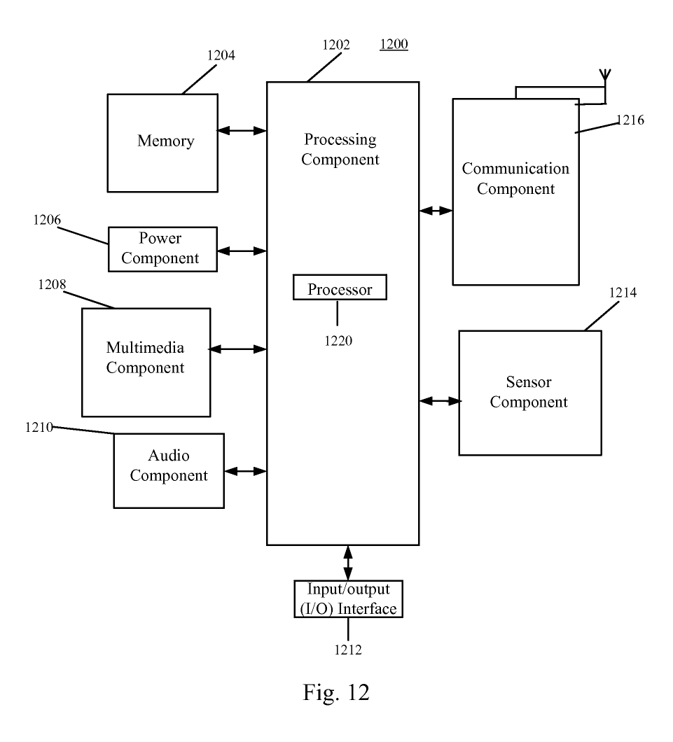

FIG. 12 is a block diagram of another exemplary apparatus 1200 for controlling a smart light consistent with embodiments of the present disclosure. The apparatus 1200 may be, for example, a cloud server, a mobile phone, a computer, a digital broadcast terminal, a messaging device, a gaming console, a tablet, a medical device, exercise equipment, a personal digital assistant, or the like.

Referring to FIG. 12, the apparatus 1200 includes one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the apparatus 1200, such as the operations associated with display, telephone calls, data communications, camera operations, and recording operations. The processing component 1202 may include one or more processors 1220 to execute instructions to perform all or part of methods consistent with embodiments of the present disclosure. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The memory 1204 is configured to store various types of data to support the operation of the apparatus 1200. Examples of such data include instructions for any applications or methods operated on the apparatus 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power management system, one or more power sources, and any other components associated with the generation, management, and distribution of power in the apparatus 1200.

The multimedia component 1208 includes a screen providing an output interface between the apparatus 1200 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and/or the rear camera may receive an external multimedia datum while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200, a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the apparatus 1200 and other devices. The apparatus 1200 can access a wireless network based on a communication standard, such as WiFi, 2G, 3G, or 4G, or a combination thereof. In one exemplary embodiment, the communication component 1216 receives a broadcast signal or broadcast associated information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium, such as included in the memory 1204, storing instructions executable by the processor 1220 in the apparatus 1200, for performing methods consistent with embodiments of the present disclosure. For example, the non-transitory computer-readable storage medium may be a ROM, a RAM, a CD-ROM, a magnetic tape, a floppy disc, an optical data storage device, and the like.

Operations of devices consistent with embodiments of the present disclosure are similar to the methods described above, and thus the detailed descriptions thereof are omitted here.

According to the present disclosure, a smart light can be controlled according to changes of scene statuses. As such, control of smart lights is realized and applications of the smart lights are expanded. Controlling of a smart light can be free from manual operation and be automatic, making the smart light control more convenient.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for controlling a smart light, comprising:
acquiring status information of a current scene;
judging whether the current scene complies with a preset scene condition according to the status information;
inquiring, if the current scene complies with the preset scene condition, a pre-stored light effect configuration library according to the preset scene condition to determine a light effect parameter corresponding to the preset scene condition;
generating a light control instruction corresponding to the preset scene condition, the light control instruction including the light effect parameter; and
sending the light control instruction to the smart light.

2. The method according to claim 1, further comprising:
receiving and storing the preset scene condition and the light effect parameter set by a user.

3. The method according to claim 1, wherein:
the status information includes communication event information of a target contact; and
judging whether the current scene complies with the preset scene condition includes judging whether a communication event is conducted by the target contact according to the communication event information.

4. The method according to claim 3, wherein judging whether the communication event is conducted by the target contact includes judging at least whether contents are shared by the target contact on a preset network platform or whether a communication sent by the target contact is received.

5. The method according to claim 1, wherein:
the status information includes moving object monitoring event information in a target region; and
judging whether the current scene complies with the preset scene condition includes judging whether a moving object passes in the target region according to the moving object monitoring event information.

6. The method according to claim 1, wherein
the status information includes device access event information in a target region, the device access event information including a device identity and a device access time; and
judging whether the current scene complies with the preset scene condition includes judging, according to the device access event information, whether a specific device conducted an access in the target region for a first time within a preset duration.

7. The method according to claim 6, wherein:
the status information includes time information; and
judging whether the current scene complies with the preset scene condition further includes judging whether a current time reaches a preset time according to the time information.

8. The method according to claim 1, wherein:
the status information includes time information; and
judging whether the current scene complies with the preset scene condition includes judging whether a current time reaches a preset time according to the time information.

9. The method according to claim 1, wherein inquiring the pre-stored light effect configuration library to determine the light effect parameter includes inquiring the pre-stored light effect configuration library to determine at least one of a light on-off parameter, a light flickering times parameter, a light color parameter, or a light intensity parameter corresponding to the preset scene condition.

10. An apparatus for controlling a smart light, comprising:
a processor; and
a non-transitory computer-readable storage medium storing instructions that, when executed by the processor, cause the processor to:
acquire status information of a current scene;
judge whether the current scene complies with a preset scene condition according to the status information;
inquire, if the current scene complies with the preset scene condition, a pre-stored light effect configuration library according to the preset scene condition to determine a light effect parameter corresponding to the preset scene condition;
generate a light control instruction corresponding to the preset scene condition, the light control instruction including the light effect parameter; and
send the light control instruction to the smart light.

11. The apparatus according to claim 10, wherein the instructions further cause the processor to:
receive and store the preset scene condition and the light effect parameter set by a user.

12. The apparatus according to claim 10, wherein:
the status information comprises communication event information of a target contact; and
the instructions further cause the processor to:
judge whether a specific communication event is conducted by the target contact according to the communication event information.

13. The apparatus according to claim 12, wherein the instructions further cause the processor to:
judge at least whether contents are shared by the target contact on a preset network platform or whether a communication sent by the target contact is received.

14. The apparatus according to claim 10, wherein:
the status information includes moving object monitoring event information in a target region; and
the instructions further cause the processor to:
judge whether a moving object passes in the target region according to the moving object monitoring event information.

15. The apparatus according to claim 10, wherein:
the status information includes device access event information in a target region, the device access event information including a device identity and a device access time; and
the instructions further cause the processor to:
judge, according to the device access event information, whether a specific device conducted an access in the target region for a first time within a preset duration.

16. The apparatus according to claim 15, wherein:
the status information includes time information; and
the instructions further cause the processor to:
judge whether a current time reaches a preset time according to the time information.

17. The apparatus according to claim 10, wherein:
the status information includes time information; and
the instructions further cause the processor to:
judge whether a current time reaches a preset time according to the time information.

18. The apparatus according to claim 10, wherein the instructions further cause the processor to:
inquire the pre-stored light effect configuration to determine at least one of a light on-off parameter, a light flickering times parameter, a light color parameter, or a light intensity parameter corresponding to the preset scene condition.

19. A non-transitory computer-readable storage medium storing instructions that, when executed by a processor in a device, cause the device to:
acquire status information of a current scene;
judge whether the current scene complies with a preset scene condition according to the status information;
inquire, if the current scene complies with the preset scene condition, a pre-stored light effect configuration library according to the preset scene condition to determine a light effect parameter corresponding to the preset scene condition;
generate a light control instruction corresponding to the preset scene condition, the light control instruction including the light effect parameter; and
send the light control instruction to a smart light.
